(19) United States
(12) Patent Application Publication
(10) Pub. No.: US 2022/0405709 A1
(43) Pub. Date: Dec. 22, 2022

(54) Smart Notifications Based Upon Comment Intent Classification

(71) Applicant: Microsoft Technology Licensing, LLC, Redmond, WA (US)

(72) Inventors: Elnaz NOURI, Seattle, WA (US); Ryen W. WHITE, Woodinville, WA (US); Robert A. SIM, Bellevue, WA (US); Carlos TOXTLI, Westover, WV (US)

(73) Assignee: Microsoft Technology Licensing, LLC, Redmond, WA (US)

(21) Appl. No.: 17/349,870

(22) Filed: Jun. 16, 2021

(51) Int. Cl. G06Q 10/10; G06F 40/30; G06F 40/169; G06N 20/00

(52) U.S. Cl. CPC G06Q 10/103; G06F 40/30; G06F 40/169; G06Q 10/1093; G06N 20/00

(57) ABSTRACT

Aspects of the present disclosure relate to systems and methods for generating smart notifications for comments associated with collaborative content. A machine learning model is disclosed which is operable to receive a comment and contextual information related to the comment. Based upon the received input, the machine learning model is able to determine a classification for an intent associated with the comment. Based upon the determined intent, a comment is identified as requiring action by one or more of the collaborative users. Aspects of the present disclosure generate a smart notification that can be presented as part of a collaborative user interface to highlight comments that require action.

### BACKGROUND

Comments are a common communication channel used during the creation of collaborative content. Given the sheer volume of comments that may be associated with collaborative content, it is often hard to identify which comments require action by a user and which comments do not.

It is with respect to these and other general considerations that embodiments have been described. Also, although relatively specific problems have been discussed, it should be understood that the embodiments should not be limited to solving the specific problems identified in the background.

### SUMMARY

Aspects of the present disclosure provide a smart notification system which is operable to determine the intent associated with comments in collaborative content and, based upon the intent, generate smart notifications as to which comments require the attention of one or more collaborative users. A machine learning model is employed to receive determine an intent for the comments. Based upon the determined intent, the systems and methods disclosed herein identify actionable comments, e.g., comments that request or require and action, and generate a smart notification for the actionable comments. In further examples, the systems and methods disclosed herein are further operable to determine the action requested by the comment and, when possible, suggest and/or automatically modify the collaborative content based upon the requested action.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 depicts an exemplary system 100 for providing smart notifications for collaborative content.

FIG. 2 depicts an exemplary method for generating smart notifications.

FIG. 3 provides an exemplary machine learning model for determining one or more intents of a comments.

FIG. 4 depicts an exemplary method for automatically performing an action to collaborative content based upon an actionable comment.

FIG. 5 depicts and exemplary method for generating a smart notification.

FIG. 6 is a block diagram illustrating example physical components of a computing device with which aspects of the disclosure may be practiced.

FIGS. 7A and 7B are simplified block diagrams of a mobile computing device with which aspects of the present disclosure may be practiced.

FIG. 8 is a simplified block diagram of a distributed computing system in which aspects of the present disclosure may be practiced.

FIG. 9 illustrates a tablet computing device for executing one or more aspects of the present disclosure.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

Comments are a common communication mechanism for groups working on collaborative content. As the usage of collaborative productivity applications and web-based productivity tools, working groups rely upon comments to share information and request modifications when working on collaborative content. Using comments as a communication medium has the benefit of associating a communication with the content, or even a specific portion of content, as opposed to more traditional means of communication, such as email or instant messages, which require users to access other application to view content related communications. However, as the number of comments associated with the collaborative content increases, it becomes difficult for a collaborative user to determine which comments need addressing and, in some cases, which comments are relevant to the collaborative user's task.

In addition to the sheer volume of comments that may be associated with a piece of collaborative content, the diversity of purpose, or intent, of each comment makes it difficult to determine which comments require action and which comments do not. For example, some comments can ask for a specific task to be performed, like requesting changes to the collaborative content, while other comments may be more social in nature, such as offering praise for a specific portion of the collaborative content. These difficulties are further compounded by the fact that many applications handle comments differently, and in many instances, do not provide a user interface that allow users to easily browse comments, let alone provide additional information that can be helpful to users addressing the comments. Due to these factors, it is difficult for collaborative users to quickly and efficiently navigate to and address comments within a collaborative content application.

Aspects of the present disclosure address these problems by providing a smart notification system which is operable to determine the intent associated with comments in collaborative content and, based upon the intent, generate smart notifications as to which comments require the attention of one or more collaborative users. A machine learning model is employed to receive the comments and contextual information. The machine learning model determines an intent for the comments based upon said received input. Using the determined intent, the systems and methods disclosed herein identify actionable comments, e.g., comments that request or require and action, and generate a smart notification for the actionable comments. In further examples, the systems and methods disclosed herein are further operable to determine the action requested by the comment and, when possible, suggest a modification and/or automatically modify the collaborative content based upon the requested action. In examples, a specific modification may be suggested or applied. For example, the comment itself may loosely request or otherwise define a task to be performed. The systems and methods disclosed may suggest or automatically apply specific types of modifications to address the request made by the comment. While examples provided herein relate to analyzing comments used in collaborative content, one of skill in the art will appreciate that the systems and methods disclosed herein may be employed on comments associated with content that is not necessarily collaborative. For example, a user may leave comments in content directed towards herself. The aspects disclosed herein may be similarly employed to analyze comments user's insert for themselves in order to generate smart notifications for the user based upon their own comments.

Among other benefits, aspects of the present disclosure provide an enhanced user interface that can be used with a variety of different collaborative applications. The enhanced user interface identifies actionable comments in a manner that allows for either the automatic performance of the action associated with the comment or a smart notification to perform the action associated with the comment. This reduces the amount of time spent by multiple devices accessing the collaborative content, which saves battery life when using mobile devices and reduces the bandwidth need for devices hosting the collaborative content.

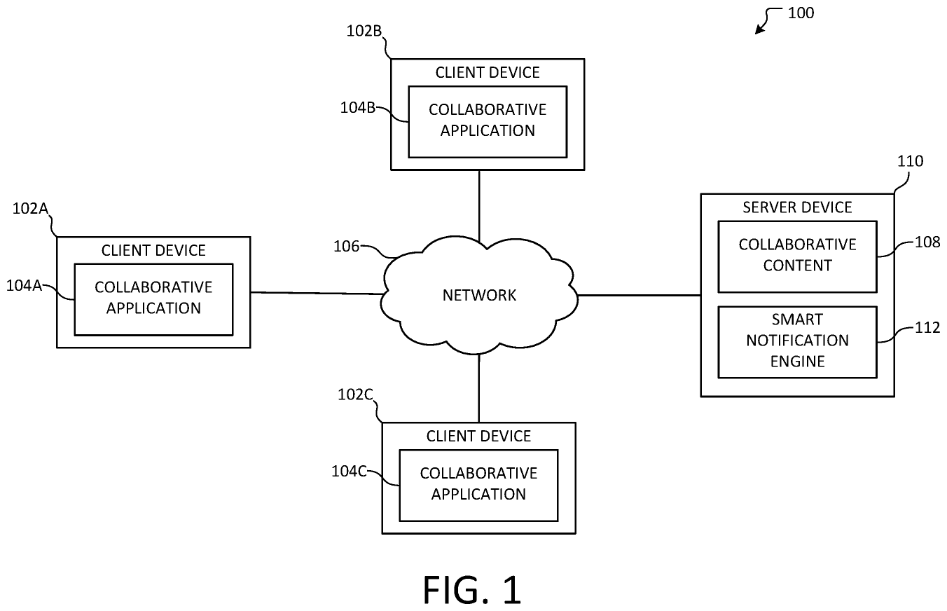

FIG. 1 depicts an exemplary system 100 for providing smart notifications for collaborative content. As depicted in system 100, multiple client devices 102A, 102B, and 102C, access collaborative content stored on server device 110 via network 106 using respective collaborative applications 104A, 104B, and 104C. The depicted client devices may be any type of computing device, including, but not limited to, personal computers, laptops, tablets, and smartphones. Server device 110 may also be any type of computing device, including, but not limited to, personal computers, laptops, tablets, and smartphones. Further, while the exemplary system illustrates the collaborative content 108 being hosted by server device 110, in alternate examples the collaborative content may be hosted or stored locally by one of the client devices. Client devices 102A, 102B, and 102C may access the collaborative content 108A simultaneously or at different times. Although a specific number of client devices 102A, 102B, and 102C and server device 110 are shown as part of system 100, one of skill in the art will appreciate that system 100 can be scaled to include more or fewer devices without departing from the spirit of this disclosure.

Collaborative content 108 may be any type of content, such as, but not limited to, a document, a spreadsheet, a slide presentation, an image, a video, a webpage, or any other type of digital content. Similarly, collaborative applications 104A, 104B, and 104C may be any type of application operable to access and/or modify the collaborative content 108 such as, but not limited to, a word processing application, a spreadsheet application, a presentation application, a browser, an integrated development environment, or the like. One of skill in the art will appreciate that collaborative applications 104A, 104B, and 104C need not be the same application or the same type of application so long as they are able to access and/or modify the collaborative content 108.

The client devices 102A, 102B, and 102C access and modify collaborative content 108. As part of the modification process, client devices 102A, 102B, and 102C may generate or cause the generation of comments that are associated with the collaborative content 108. The comments may be associated with the collaborative content as a whole or may be associated with specific portions of the collaborative content 108. The comments are associated with collaborative content 108 in a manner that allows the comments to be displayed or accessed as part of collaborative content 108. Smart notification engine 112 is operable to access collaborative content 108 and the associated comments. As will be discussed in further detail below, smart notification engine 112 analyzes the comments using a machine learning model to determine an intent for the one or more comments. In one example, each individual comment, or a subset of the comments, may be associated with an individual intent. Alternatively, a group of comments, such as nested comments or comments associated with the same or similar portion of the collaborative content 108, may be assigned a group intent.

Upon determining an intent for one or more comments, the smart notification engine 112 is operable to filter the set of comments based upon the determined intent in order to determine which comments are actionable. As used herein, an actionable comment is a comment that requests performance of an action, such as a modification, on the collaborative content. The actionable comment may be directed to a specific user of a group of collaborative users or the group of collaborative users as a whole. Upon identifying one or more actionable comments, the smart notification engine 112 determines a smart notification to associate with the one or more actionable comments. In some aspects, a smart notification is a user interface indicator which highlights or otherwise draws the attention of a collaborative user to the comment. For example, the smart notification may highlight actionable comments using a certain color or graphical indicator, may automatically direct the user to the one or more actionable comments upon accessing the collaborative content, may be in the form of an additional user interface element which directly navigates users to an actionable content or through a series of actionable content, or the like. Alternatively, or additionally, the smart notification engine 112 may draw attention to one or more actionable comments in other ways, such as generation of a task or to-do list based upon an actionable comment, sending a message to one or more collaborative users notifying them of an actionable comments (e.g., via email, instant message, text message, etc.), generate a calendar invite to event one or more collaborative users to address the actionable comment, or the like. The format and/or type of communication may be selected based upon properties of the comment that can be inferred from the comment or explicitly provided in the comment. For example, if it is determined that the comment requires immediate attention or is otherwise indicated as a high priority, the smart notification may be a SMS text or an instant message that is likely to quickly receive attention, while lower priority or lower urgency comments may be addressed by a smart notification in the form of an email. While the smart notification engine is depicted as residing on server 110 along with collaborative content 108, the smart notification engine 112 may also reside on one or more of client devices 102A, 102B, and 102C or on a separate server device not shown in FIG. 1.

Alternatively, or additionally, smart notification engine 112 may be operable to automatically address an actionable comment. In examples, once smart notification engine 112 determines that a comment is actionable based upon the determined intent, smart notification engine 112 may further analyze the comment to determine the requested action. In examples, the requested action may be determined using machine learning, such as by providing the comment to a machine learning model trained to identify actions associated with a type of collaborative content. Upon determining the requested action, smart notification engine 112 may determine whether it, or an application associated with the smart notification engine 112, can automatically perform the action requested in the actionable comment. The determination as to whether the smart notification engine 112 can perform the action may be based upon whether the smart notification engine 112 is capable of performing the action itself, or otherwise instructing an application associated with the collaborative content 108 to perform the action, whether the smart notification engine 112 has permission to access and/or modify the collaborative content 112, and/or whether a user profile associated with the collaborative content 108 allows for the automatic collaboration of the collaborative content. If the smart notification engine 112 can modify the collaborative content, the smart notification engine 112 will perform the modification, or cause another application to perform the modification. In certain aspects, the smart notification engine 112 will generate an indication in the user interface that highlights the modification and the comment the modification was based upon to the group of collaborative users and provide a user interface component which will allow for the acceptance or rejection of the modification. If the modification is rejected, the collaborative content 108 will revert to a prior state which does not contain the rejected modification.

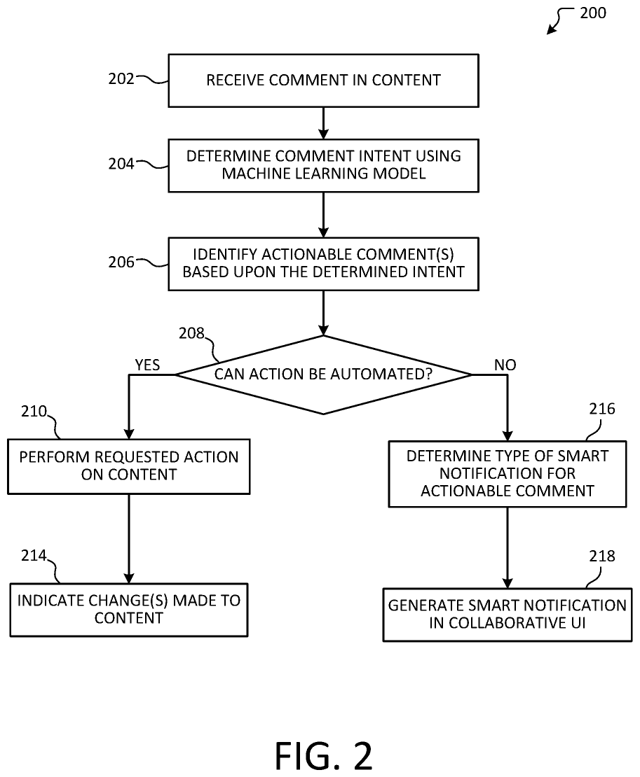

FIG. 2 depicts an exemplary method 200 for generating smart notifications. In one example, the method 200 may be performed by a smart notification engine, such as smart notification engine 112 of FIG. 1. Alternatively, or additionally, the method 200 may integrated and performed by an application accessing the collaborative content. At operation 202, one or more comments included in or otherwise associated with the collaborative content may be received or otherwise identified. In one example, the collaborative content may be parsed identify or extract comments associated with the content. One of skill in the art will appreciate that any process capable of receiving, extracting, or otherwise identifying specific content or a specific type of content may be employed at operation 202 to receive one or more comments to analyze. In further examples, in addition to receiving, extracting, and/or identifying the one or more comments, operation 202 may receive or gather additional information associated with the comment such as, but not limited to, the specific piece of content associated with the comment, the position of the comment in the collaborative content or relative to other comments, information related to the user who created the comment and/or collaborative users who have accessed the collaborative content, or any other type of information that can be used to determine contextual information about the comment. As a non-limiting example, consider a scenario where the collaborative content is a document. Collection of the additional information may include, for example, the document sentence associated with the comment, the paragraph associated with the comment, a page the document, a section associated with the comment, the location of the comment in the document, an image associated with the comment, a table associated with the comment, a spreadsheet or cell associated with the comment, or the like. One of skill in the art will appreciate that the type of additional information gathered at operation 202 may vary based upon the type of collaborative content associated with the comment.

Aspects disclosed herein may be practiced regardless of the type or format of a comment. For example, while the exemplary comments discussed herein generally relate to comments in a text format, aspects of the present disclosure may also be employed on audio, video, or image based comments as well. One of skill in the art will appreciate that the process employed to receive or otherwise identify a comment and comment data may vary depending on the type of comment. For example, speech recognition may be used to receive or identify audio comments, video or image analysis or recognition tools may be employed to receive or identify video or image comments, etc.

At operation 204, an intent of the one or more comments is determined. The intent of a comment may be associated with one or more distinct categories of intent associated with the collaborative content. For example, three distinct categories and subcategories for comment intent may be associated with a smart notification system. These categories may be: modification, information exchange, and social communication.

Modification comments are often used to manage changes in a document. The definition of a modification can further be divided into two distinct sub-intents: modification request and execution status. A Modification Requesting is when a comment creator is asking a collaborative user to perform some changes to the collaborative content, and an Execution status may be associated with a comment in which a collaborative user is reporting a change done or committing to perform a change.

The information exchange intent category includes the communication of information, e.g., the comment creator intends to seek information or to share information. Some common uses of information exchange comments include, but are not limited to, asking questions, requesting or sharing content, etc. In certain examples, two sub-intents may be associated with this category: share information and request information. Sharing information is related to comments where the comment creator is sharing information or content with the collaborative users, such as context, clarifications, or references. Requesting information denotes a scenario where the comment author is requesting information that can be potentially responded to, or it can lead to a change.

The social communication intent category includes, for example, casual messages such as greeting messages or thank you notes, which are exchanged between the group of collaborative users. Exemplary sub-intents related to this category include, but are not limited to, acknowledgement, feedback, and discussion.

Comments analyzed by sentences often contain more than one intent, and the intents are not mutually exclusive. For example, a comment could contain sentences that belong to Modification and an Information Exchange intents. For example, the Modification and Information Exchange intent are often related to the same comment, while Acknowledgment and Execution sub-intents are less likely to co-exist in the same comment. While specific intents and sub-intents are provided herein, one of skill in the art appreciates that the specific intents and sub-intents are merely examples of intents that may be detected at operation 504. One of skill in the art will appreciate that other types of intents may be detected by the systems and methods disclosed herein.

A machine learning model may be used determine the intent or intents of a comments. In examples, the comment and/or additional information (e.g., contextual information) associated with the comment may be analyzed using a machine learning model to determine the intent. In examples, a number of different types of machine learning models and/or algorithms may be utilized at operation 204 to determine an intent or intents of a comment including, but not limited to, a support vector machines (SVM), logistic regression, a bi-directional recurrent neural network (RNN), a diffusion convolutional recurrent neural network (DCRNN), a multi-context recurrent neural network (MCRNN), etc. The machine learning model employed at operation 204 may be trained using a corpus of content containing comments and their associated content. The training process may be supervised or unsupervised. Upon receiving the comment and/or additional information related to the comment, the machine learning model utilized at operation 204 is operable to determine one or more intents to associate with the comment. In further examples, one or more intents may be associated with a group of comments rather than individual comments. Further, additional information or attributes may be processed to classify a comment that may not necessarily implicate an intent, such as comment urgency, comment importance, the position of the comment relative to the content and/or other comments, or the like. One of skill in the art will appreciate that the aspects disclosed herein are operable to consider any type of information or factors that are relevant to determining whether a smart notification is appropriate for a comment.

Upon identifying one or more intents at operation 204, flow continues to operation 206 where one or more actionable comments are identified. Actionable comments are comments that require an action in response to the comment. The action may be a modification to the collaborative content or a response to the comment itself. Actionable contents are identified based upon the determined intent. As previously discussed, some types of intents generally require an action, such as a modification intent and/or a requesting information sub-intent. At operation 204, the contents may be filtered by intent and/or sub-intent in order to identify comments that require an action.

Having identified the actionable comments associated with the collaborative content, flow continues to operation 208 where the method 200 determines whether one or more actions associated with the comment can be automated. For example, some actions, such as changing a font size, formatting, a color of a specific portion of content, etc., may be automatically performed by the device performing the method 200 while other actions, such as providing additional information, may not be automated. At operation 208, the one or more actions associated with an actionable comment are identified, for example, using a machine learning model such as the machine learning model employed at operation 204 or a different machine learning model trained to identify automated actions. Upon identifying the one or more actions, the device performing the method 200 determines whether it has the capability and/or permission to perform the requested one or more actions. If the device is capable of performing the action and permitted to do so, flow branches YES to operation 210.

At operation 210, the one or more requested actions are automatically performed by the device performing the method 200. For example, the collaborative content may automatically be modified in accordance with the one or more actions. Flow continues to operation 214 where an indication of the one or more changes automatically made to the collaborative content is provided. In one example, the indication may include a graphical indication highlighting the change and/or information indicating what content was changed, similar to a track changes feature common in word processing applications. In further examples, a user interface element may be provided that directs the collaborative users to the changes within the content. Said user interface element may also be operable to receive a selection indicating acceptance or rejection of the change. In such circumstances, upon automatically performing the modification, the device performing the method 200 may save a copy of the collaborative content, or a prior state of the collaborative content, so the change can be undone.

Returning to operation 208, if the one or more actions cannot be automated, flow branches NO to operation 216. At operation 216, a type of smart notification is determined by the system. As noted above, there are many different ways a smart notification can be generated to draw attention to the actionable comments, such as, for example, by highlighting the comment, providing an interface that automatically navigates to the actionable comments, causing an application to open an actionable comment when accessing the collaborative content, tasking one or more users to perform the action or otherwise address the actionable comment, sending a message to the group of collaborative users or, if determined that the actionable comment is directed towards a specific user, notifying the specific user, etc. In one example, the type of smart notification may be determined based upon user preference. For example, different collaborative users may have different preferences in how they receive notifications. In such examples, profile information associated with the collaborative users may be accessed to determine what type of smart notification to generate. Alternatively, the type of smart notification may be determined based upon the type of collaborative content and/or the type of application used to access the collaborative content. In doing so, the method 200 is operable to provide smart notifications regardless of the type of application used to access the comment, thereby ensuring that collaborative users will be notified of the actionable comment regardless of what application each individual uses to access the collaborative comment. In still further examples, multiple types of smart notifications may be determined at operation 216. Upon determining the one or more smart notifications, flow continues to operation 218 where the one or more smart notifications are generated in a collaborative user interface associated with the collaborative content, in the UI of different applications used to access the collaborative content, or via other messages such as email, instant message, or text.

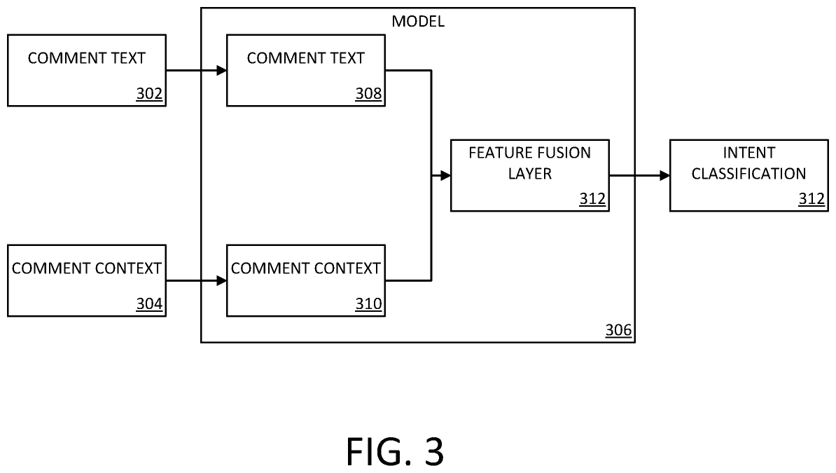

FIG. 3 provides an exemplary machine learning model for determining one or more intents of a comments. In examples, machine learning model 306 may receive the comment text 302 and contextual information 304 related to the comment as input. Comment text 302 may be the entire text of the comment or individual comment sentences. The comment context may be information related to the collaborative content, information related to other comments, or information related to the comment author or other collaborative users, or the like. For example, the comment context information may include a selected portion of the collaborative content associated with the comment (e.g., selected text, paragraph text, comment thread text, a portion of an image, a frame of a video, etc.). One of skill in the art will appreciate that the type of information that may be part of the comment text 302 may vary depending upon the type of collaborative content associated with the comment, the position of the comment relative to the collaborative content or other comments, etc.

In the depicted example, the machine learning model 306 comprises a target encoder 308 and a context encoder 310. The target encoder 308 is operable to extract and encode features of the comments. In one example, the target encoder may extract n-grams from the comment and encode the feature values for the extracted n-grams. In alternate examples, the target encoder 308 may enrich the representation of words in the comments. In such examples, a word within a comment is transformed into a dense vector using a word embedding matrix. A bi-directional RNN with GRU cells may then be applied to the comment to determine hidden states for one or more words in the comment. The forward hidden state and the backward hidden state and the backward hidden state generated using the bi-directional RNN may then be concatenated to encode information about a word in the comment and its surrounding words. While specific types of target encoders have been described herein, one of skill in the art will appreciate that these types of encoders are provided for illustrative purposes and other types of target encoders may be employed as part of the model 306 without departing from the scope of this disclosure.

The context encoder 310 is operable to extract features from the comment, related comments, and/or collaborative content associated with the content. In one example, the context encoder 310 may be an n-gram feature extractor. Alternatively, or additionally, the context encoder 310 encodes portions of the collaborative content associated with the comment. For example, when the collaborative content is a document, each sentence of the content associated with the content may be encoded in a fixed vector space. In some examples, the same type of encoder as the target encoder may be used to determine hidden states for words in the document associated with the comment. Having the hidden states of the words, there are several ways to build a sentence representation, such as averaging and max-pooling over the hidden state. These may treat all words of the sentence equally. But, some keywords in the sentences tend to be more important for identifying the user intent. For instance, “add”, “change”, “remove” are strong signals for the Modification intent. As such, an attention operation may be applied on the sentence to generate a sentence representation from the weighted average of the hidden states. The words with larger attention weights represent the important words which can be learned during the model training. The attention operation takes the hidden states as input and outputs the weight vector.

The output from both the target encoder 308 and context encoder 310 may be provided to a feature fusion layer 312 of the model 306. In order to augment the comment features with context features, the feature fusion layer concatenates the comment and context feature vectors generated by the target encoder 308 and context encoder 310, respectively. In one example, the feature fusion layer 312 generates a matrix in which a row represents a target sentence and each element represent how each sentence is relevant to the target sentence. Upon creation of the matrix, the matrix may be normalized and another attention operation may be applied to the matrix to generate a context aware representation of the target sentence of the comment. The feature fusion layer 312 generates a feature vector which is provided to a classifier in order to determine one or more intents and or sub-intents of the comment. In one example, a softmax function may be applied to the context aware representation to generate an intent prediction. An intent may then be determined for the comment based upon the prediction probability. The model 306 provides the one or more predicted intents as output, as illustrated by intent classification 314.

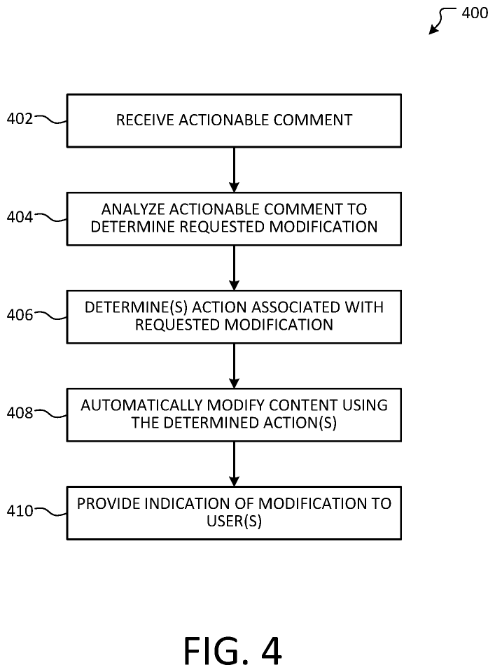

FIG. 4 depicts an exemplary method 400 for automatically performing an action to collaborative content based upon an actionable comment. At operation 402, an actionable comment is received. As previously discussed an actionable comment may be determined based upon the comment's intent determined using a neural network model, such as model 306 depicted in FIG. 3. Upon receiving the actionable comment, flow continues to operation 404 where the comment is analyzed to determine a requested modification. For example, the comment may be processed using another neural network model to identify one or more actions in the comment. Alternatively, the text of the comment may be parsed at operation 404 to identify keywords associated with known requests. At operation 404, one or more actions to be performed are identified based upon the identified request. For example, the determined request may be translated to one or more actions needed to perform the requested modification. For example, a template may be access that identifies operations required to perform a requested modification. As part of this operation, the method 400 may also determine whether or not the device performing the method 400 is capable of and/or allowed to perform the one or more actions.

Upon determining the one or more actions associated with the modification request, flow continues to operation 402 where the method 400 automatically performs the actions to modify the collaborative content. In one example, the device or application performing the operation 400 may execute the actions to perform the modification. Alternatively, or additionally, the device or application performing the method 400 may instruct or otherwise cause another application or applications to perform the one or more actions. Flow then continues to operation 410 where an indication of the one or more changes automatically made to the collaborative content is provided. As discussed, the indication may include a graphical indication highlighting the change and/or information indicating what content was changed, similar to a track changes feature common in word processing applications. In further examples, a user interface element may be provided that directs the collaborative users to the changes within the content. Said user interface element may also be operable to receive a selection indicating acceptance or rejection of the change. In such circumstances, upon automatically performing the modification, the device performing the method 200 may save a copy of the collaborative content, or a prior state of the collaborative content, so the one or more changes made through performance of the one or more actions can be undone. In some examples, multiple states of the collaborative content may be stored, e.g., a new state before each action is performed, in ordo to facilitate undoing some, but not all, of the modifications.

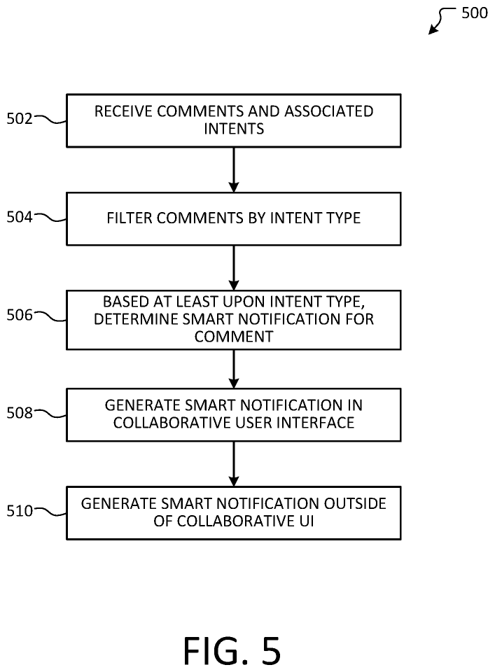

FIG. 5 depicts and exemplary method for generating a smart notification. Flow begins at operation 502 where one or more comments are received. The received comments received at operation 502 are associated with one or more intents determined using a machine learning model, such as machine learning model 306 shown in FIG. 3. Upon receiving the comments and their associated intents, the received comments are filtered at operation 504. In aspects, the comments are received based upon their determined intent(s) and/or sub-intent(s). As previously discussed, the intent of a comment can be used to determine whether the comment is actionable or not. For example the modification intent and request information sub-intent previously discussed indicate that the comment should be addressed by either performing a modification to the content, providing an answer to the commenter, or both. As such, intents known to be associated with an action to be performed or require a response can be filtered from other comments whose intent does not require an action or response. As such, the filter operation 504 can be used to determine comments that require an action or answer.

Upon identifying a subset of actionable comments based upon their determined intent, flow continues to operation 506 ware a type of smart notification is determined for the identified comments. As previously noted, the type of smart notification determined may be based upon the comment itself, the collaborative content, the type of collaborative content, the preferences of the author of the comment (e.g., indicated by the comment itself or a user profile), the preferences of one or more collaborative users working with the collaborative content, device and/or application capabilities, or the like. At operation 508, the one or more determined smart notifications are generated as part of a collaborative user interface or an application user interface used to access the collaborative content. In examples, the smart notifications may be associated with the collaborative content itself, such that when a user accesses the collaborative content, a user interface indication is triggered and/or displayed regardless of the type of application used to access the content. Exemplary graphical smart notifications include, but are not limited to, highlighting the comment, providing an interface that automatically navigates to the actionable comments, causing an application to open an actionable comment when accessing the collaborative content, providing an auditory notification, utilizing a digital assistant to provide the smart notification, etc.

As previously discussed, smart notifications can also be provided outside of a collaborative user interface. For example, actions associated with an actionable comment can be added to a user's task list or to-do list, a calendar event to address the comment may be generated, an email, text message, or instant message may be sent notifying one or more users about the comment and/or a requested action associated with the comment, or the like. At operation 510, these type of notifications may be generated and provided to users associated with the collaborative content or one or more specific users addressed by the comment.

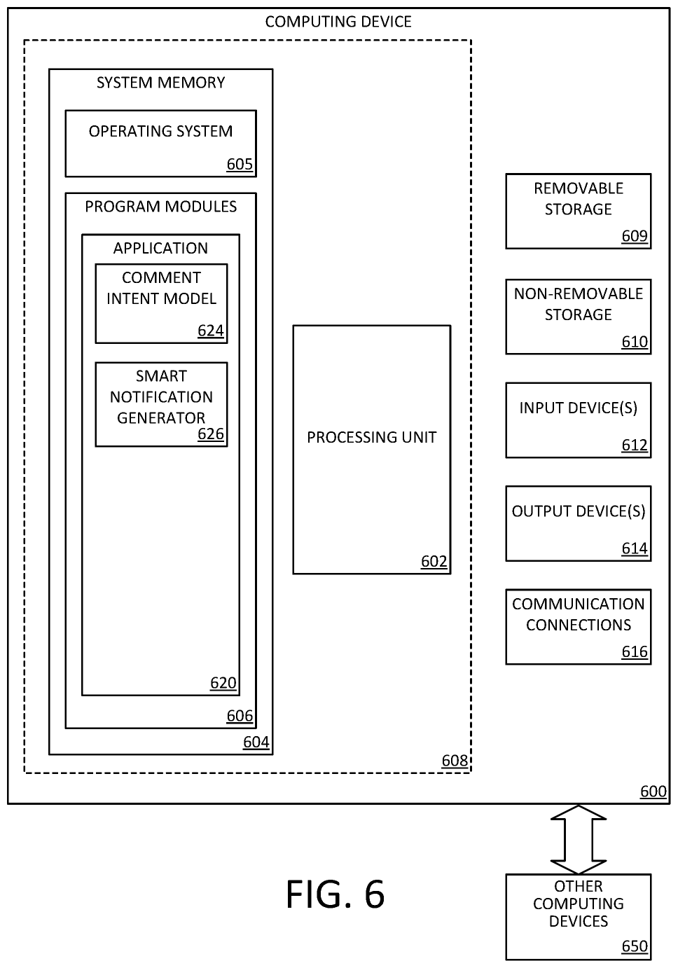

FIGS. 6-9 and the associated descriptions provide a discussion of a variety of operating environments in which aspects of the disclosure may be practiced. However, the devices and systems illustrated and discussed with respect to FIGS. 6-9 are for purposes of example and illustration and are not limiting of a vast number of computing device configurations that may be utilized for practicing aspects of the disclosure, described herein.

FIG. 6 is a block diagram illustrating physical components (e.g., hardware) of a computing device 600 with which aspects of the disclosure may be practiced. The computing device components described below may be suitable for the computing devices described above, including devices 102, 104, 106, and/or 108 in FIG. 1A and devices 152, 154, 156, and 158 in FIG. 1B. In a basic configuration, the computing device 600 may include at least one processing unit 602 and a system memory 604. Depending on the configuration and type of computing device, the system memory 604 may comprise, but is not limited to, volatile storage (e.g., random access memory), non-volatile storage (e.g., read-only memory), flash memory, or any combination of such memories.

The system memory 604 may include an operating system 605 and one or more program modules 606 suitable for running software application 620, such as one or more components supported by the systems described herein. As examples, system memory 604 may store comment intent model 624 and smart notification generator 626. The operating system 605, for example, may be suitable for controlling the operation of the computing device 600.

Furthermore, embodiments of the disclosure may be practiced in conjunction with a graphics library, other operating systems, or any other application program and is not limited to any particular application or system. This basic configuration is illustrated in FIG. 6 by those components within a dashed line 608. The computing device 600 may have additional features or functionality. For example, the computing device 600 may also include additional data storage devices (removable and/or non-removable) such as, for example, magnetic disks, optical disks, or tape. Such additional storage is illustrated in FIG. 6 by a removable storage device 609 and a non-removable storage device 610.

As stated above, a number of program modules and data files may be stored in the system memory 604. While executing on the processing unit 602, the program modules 606 (e.g., application 620) may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 6 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 600 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 600 may also have one or more input device(s) 612 such as a keyboard, a mouse, a pen, a sound or voice input device, a touch or swipe input device, etc. The output device(s) 614 such as a display, speakers, a printer, etc. may also be included. The aforementioned devices are examples and others may be used. The computing device 600 may include one or more communication connections 616 allowing communications with other computing devices 650. Examples of suitable communication connections 616 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 604, the removable storage device 609, and the non-removable storage device 610 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 600. Any such computer storage media may be part of the computing device 600. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

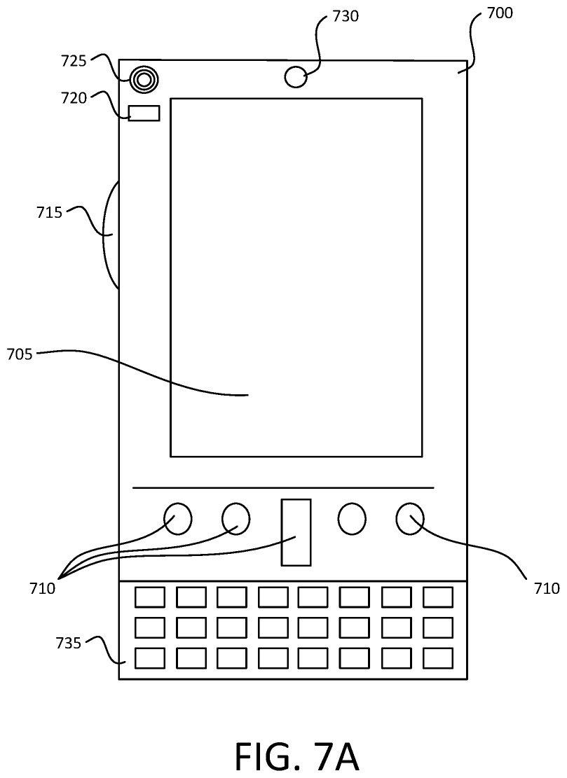

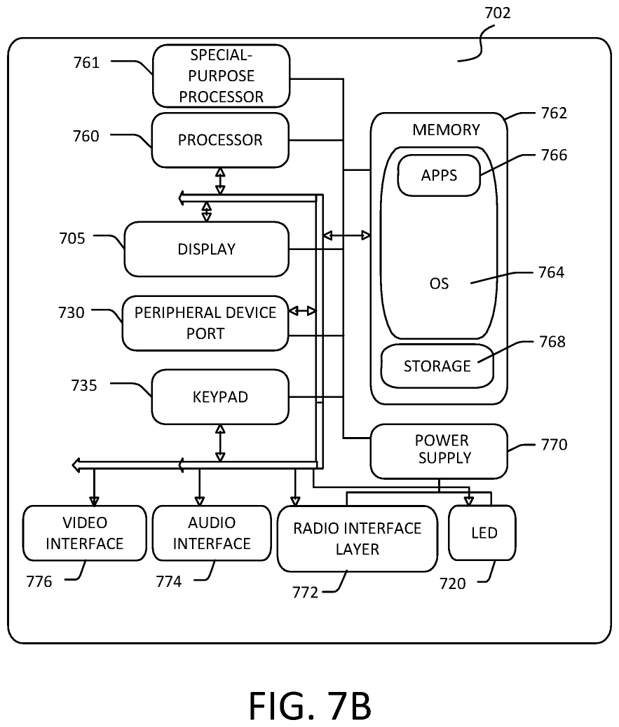

FIGS. 7A and 7B illustrate a mobile computing device 700, for example, a mobile telephone, a smart phone, wearable computer (such as a smart watch), a tablet computer, a laptop computer, and the like, with which embodiments of the disclosure may be practiced. In some aspects, the client may be a mobile computing device. With reference to FIG. 7A, one aspect of a mobile computing device 700 for implementing the aspects is illustrated. In a basic configuration, the mobile computing device 700 is a handheld computer having both input elements and output elements. The mobile computing device 700 typically includes a display 705 and one or more input buttons 710 that allow the user to enter information into the mobile computing device 700. The display 705 of the mobile computing device 700 may also function as an input device (e.g., a touch screen display).

If included, an optional side input element 715 allows further user input. The side input element 715 may be a rotary switch, a button, or any other type of manual input element. In alternative aspects, mobile computing device 700 may incorporate more or less input elements. For example, the display 705 may not be a touch screen in some embodiments.

In yet another alternative embodiment, the mobile computing device 700 is a portable phone system, such as a cellular phone. The mobile computing device 700 may also include an optional keypad 735. Optional keypad 735 may be a physical keypad or a “soft” keypad generated on the touch screen display.

In various embodiments, the output elements include the display 705 for showing a graphical user interface (GUI), a visual indicator 720 (e.g., a light emitting diode), and/or an audio transducer 725 (e.g., a speaker). In some aspects, the mobile computing device 700 incorporates a vibration transducer for providing the user with tactile feedback. In yet another aspect, the mobile computing device 700 incorporates input and/or output ports, such as an audio input (e.g., a microphone jack), an audio output (e.g., a headphone jack), and a video output (e.g., a HDMI port) for sending signals to or receiving signals from an external device.

FIG. 7B is a block diagram illustrating the architecture of one aspect of a mobile computing device. That is, the mobile computing device 700 can incorporate a system (e.g., an architecture) 702 to implement some aspects. In one embodiment, the system 702 is implemented as a “smart phone” capable of running one or more applications (e.g., browser, e-mail, calendaring, contact managers, messaging clients, games, and media clients/players). In some aspects, the system 702 is integrated as a computing device, such as an integrated personal digital assistant (PDA) and wireless phone.

One or more application programs 766 may be loaded into the memory 762 and run on or in association with the operating system 764. Examples of the application programs include phone dialer programs, e-mail programs, personal information management (PIM) programs, word processing programs, spreadsheet programs, Internet browser programs, messaging programs, and so forth. The system 702 also includes a non-volatile storage area 768 within the memory 762. The non-volatile storage area 768 may be used to store persistent information that should not be lost if the system 702 is powered down. The application programs 766 may use and store information in the non-volatile storage area 768, such as e-mail or other messages used by an e-mail application, and the like. A synchronization application (not shown) also resides on the system 702 and is programmed to interact with a corresponding synchronization application resident on a host computer to keep the information stored in the non-volatile storage area 768 synchronized with corresponding information stored at the host computer. As should be appreciated, other applications may be loaded into the memory 762 and run on the mobile computing device 700 described herein (e.g., search engine, extractor module, relevancy ranking module, answer scoring module, etc.).

The system 702 has a power supply 770, which may be implemented as one or more batteries. The power supply 770 might further include an external power source, such as an AC adapter or a powered docking cradle that supplements or recharges the batteries.

The system 702 may also include a radio interface layer 772 that performs the function of transmitting and receiving radio frequency communications. The radio interface layer 772 facilitates wireless connectivity between the system 702 and the “outside world,” via a communications carrier or service provider. Transmissions to and from the radio interface layer 772 are conducted under control of the operating system 764. In other words, communications received by the radio interface layer 772 may be disseminated to the application programs 766 via the operating system 764, and vice versa.

The visual indicator 720 may be used to provide visual notifications, and/or an audio interface 774 may be used for producing audible notifications via the audio transducer 725. In the illustrated embodiment, the visual indicator 720 is a light emitting diode (LED) and the audio transducer 725 is a speaker. These devices may be directly coupled to the power supply 770 so that when activated, they remain on for a duration dictated by the notification mechanism even though the processor 760 and other components might shut down for conserving battery power. The LED may be programmed to remain on indefinitely until the user takes action to indicate the powered-on status of the device. The audio interface 774 is used to provide audible signals to and receive audible signals from the user. For example, in addition to being coupled to the audio transducer 725, the audio interface 774 may also be coupled to a microphone to receive audible input, such as to facilitate a telephone conversation. In accordance with embodiments of the present disclosure, the microphone may also serve as an audio sensor to facilitate control of notifications, as will be described below. The system 702 may further include a video interface 776 that enables an operation of an on-board camera 730 to record still images, video stream, and the like.

A mobile computing device 700 implementing the system 702 may have additional features or functionality. For example, the mobile computing device 700 may also include additional data storage devices (removable and/or non-removable) such as, magnetic disks, optical disks, or tape. Such additional storage is illustrated in FIG. 7B by the non-volatile storage area 768.

Data/information generated or captured by the mobile computing device 700 and stored via the system 702 may be stored locally on the mobile computing device 700, as described above, or the data may be stored on any number of storage media that may be accessed by the device via the radio interface layer 772 or via a wired connection between the mobile computing device 700 and a separate computing device associated with the mobile computing device 700, for example, a server computer in a distributed computing network, such as the Internet. As should be appreciated such data/information may be accessed via the mobile computing device 700 via the radio interface layer 772 or via a distributed computing network Similarly, such data/information may be readily transferred between computing devices for storage and use according to well-known data/information transfer and storage means, including electronic mail and collaborative data/information sharing systems.

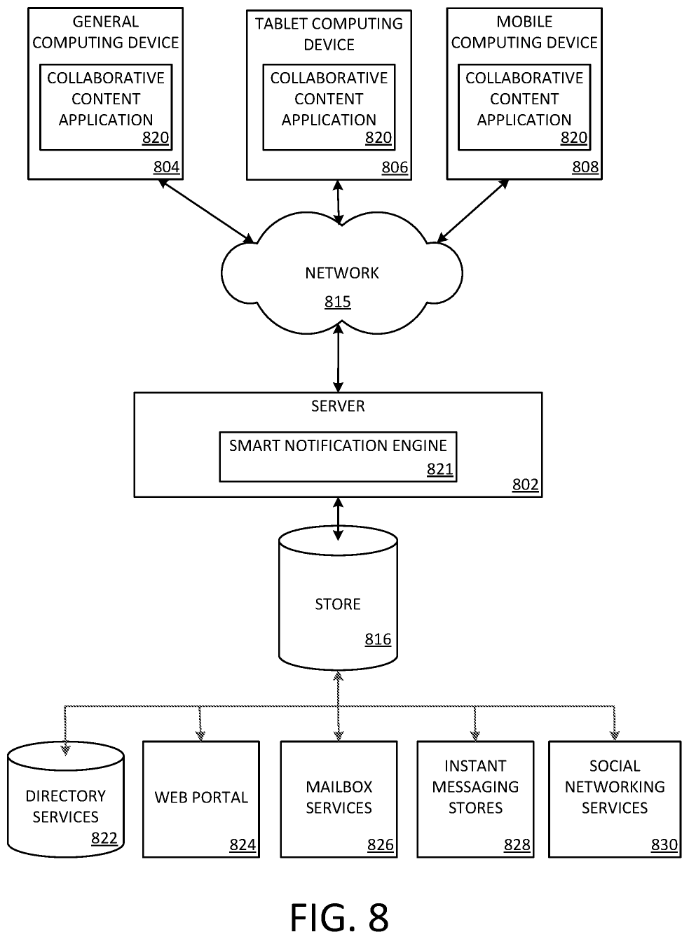

FIG. 8 illustrates one aspect of the architecture of a system for processing data received at a computing system from a remote source, such as a personal computer 804, tablet computing device 806, or mobile computing device 808, as described above. Content displayed at server device 802 may be stored in different communication channels or other storage types. For example, various documents may be stored using a directory service 822, a web portal 824, a mailbox service 826, an instant messaging store 828, or a social networking site 830.

A collaborative content application 820 may be employed by a client that communicates with server device 802, and/or smart notification engine 821 (e.g., performing aspects described herein) may be employed by server device 802. The server device 802 may provide data to and from a client computing device such as a personal computer 804, a tablet computing device 806 and/or a mobile computing device 808 (e.g., a smart phone) through a network 815. By way of example, the computer system described above may be embodied in a personal computer 804, a tablet computing device 806 and/or a mobile computing device 808 (e.g., a smart phone). Any of these embodiments of the computing devices may obtain content from the store 816, in addition to receiving graphical data useable to be either pre-processed at a graphic-originating system, or post-processed at a receiving computing system.

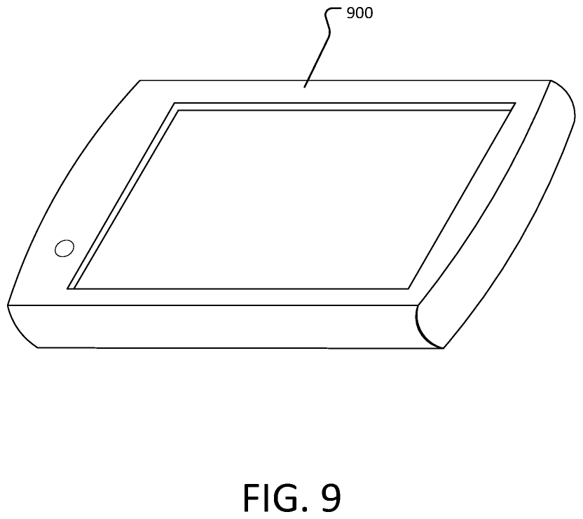

FIG. 9 illustrates an exemplary tablet computing device 900 that may execute one or more aspects disclosed herein. In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use claimed aspects of the disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general concept embodied in this application that do not depart from the broader scope of the claimed disclosure.

What is claimed is:

1. A system comprising:
at least one processor; and
memory storing instructions that, when executed by the at least one processor, causes the system to perform a set of operations, the set of operations comprising:
receiving at least one comment associated with collaborative content;
determining a content intent category for the at least one comment, wherein the content intent category is determined using a machine learning model trained to classify comment intent;
based upon the content intent category, identifying the comment as an actionable comment;
determining a smart notification for the actionable comment; and
generating the smart notification.

2. The system of claim 1, wherein the content intent category includes: a modification intent, and information exchange intent, and a social communication intent.

3. The system of claim 1, wherein determining the content intent category comprises providing the comment and contextual information associated with the comment as input to the machine learning model.

4. The system of claim 3, wherein providing the comment as input comprises one of:
providing text of the comment as a whole; or
providing a subset of the comment text.

5. The system of claim 3, wherein providing contextual information associated with the comment as input comprises at least one of:
providing a portion of the collaborative comment;
providing information about an author of the comment;
providing information about one or more collaborative users; or
providing information related to other comments associated with the collaborative content.

6. The system of claim 5, wherein the collaborative content is a document, and wherein the portion of the collaborative content comprises one or more of:
a sentence of the document;
a paragraph of the document;
an image in the document;
a table in the document;
a page of the document; or
a section of the document.

7. The system of claim 1, wherein the machine learning model comprises a comment encoder, a context encoder, and a feature fusion layer.

8. A method comprising:
identifying a set of comments associated with collaborative content;
determining a content intent category for the one or more comments in the set of comments, wherein the content intent category is determined using a machine learning model trained to classify comment intent;
based upon the content intent category, identifying a subset of comments as actionable comments;
determining at least one smart notification for the subset of comments; and
generating the at least one smart notification.

9. The method of claim 1, wherein identifying the subset of comments comprises filtering the set of comments based upon comment intent categories.

10. The method of claim 1, wherein the subset of comments identified as actionable comments are filtered by a modification intent.

11. The method of claim 8, wherein generating the at least one smart notification comprises generating an indication in a collaborative user interface identifying one or more comments from the subset of comments.

12. The method of claim 11, wherein the indication comprises at least one of:
highlighting the one or more comments;
causing the collaborative content to open on the one or more comments;
causing display of a user interface element operable to navigate a user to the one or more comments; or
causing an audible indication of the collaborative content.

13. The method of claim 8, wherein generating the at least one smart notification comprises generating a task for one or more users based upon an action associated with an actionable comment from the subset of comments.

14. The method of claim 8, wherein generating the at least one smart notification comprises generating a calendar event to address an actionable comment from the subset of comments.

15. The method of claim 8, wherein generating the at least one smart notification comprises at least one of:
sending an email;
sending a text message;
sending an instant message.

16. A system comprising:
at least one processor; and
memory storing instructions that, when executed by the at least one processor, causes the system to perform a set of operations, the set of operations comprising:
receiving at least one comment associated with collaborative content;
determining a content intent category for the at least one comment, wherein the content intent category is determined using a machine learning model trained to classify comment intent;
based upon the content intent category, identifying the comment as an actionable comment;
determining an action associated with the actionable comment; and
automatically modifying the collaborative content based upon the determined action.

17. The system of claim 16, wherein the content intent category includes: a modification intent, and information exchange intent, and a social communication intent.

18. The system of claim 16, wherein automatically modifying the collaborative content comprises suggesting a specific modification to the content and applying the specific modification upon receiving approval for the modification from a user.

19. The system of claim 16, wherein automatically modifying the collaborative content comprises saving the collaborative content prior to performing the modification.

20. The system of claim 19, wherein the set of operations further comprises:
receiving an indication to undo the modification; and
loading the saved collaborative content.
